(19) United States
(12) Patent Application Publication
(10) Pub. No.: US 2014/0074353 A1
(43) Pub. Date: Mar. 13, 2014

(54) VEHICLE TELEMATICS CONTROL VIA IGNITION DETECTION

(71) Applicant: anyDATA Corporation, Irvine, CA (US)

(72) Inventors: Jin Lee, Irvine, CA (US); Albert Bae, Irvine, CA (US); Jeff Lim, Irvine, CA (US); John Kim, Irvine, CA (US)

(21) Appl. No.: 14/024,964

(22) Filed: Sep. 12, 2013

Related U.S. Application Data
(60) Provisional application No. 61/700,239, filed on Sep. 12, 2012.

(51) Int. Cl. G06F 7/00

(52) U.S. Cl. CPC G06F 7/00
USPC 701/36; 701/99

(57) ABSTRACT

A method of controlling a telematics system based on the ignition state of an engine in a vehicle. The ignition state of the engine can alternate between an on state and an off state. The method includes monitoring, by a processor a voltage level on a diagnostics connector from the vehicle and monitoring, by the processor, an indicator of engine activity such as revolutions per minute, from the diagnostics connector of the vehicle. The method also includes determining, by the processor, a condition of the ignition state of the engine of the vehicle based on the voltage level and the indicator of engine activity and changing the operating mode of the telematics system based on the ignition state of the engine. The operating mode of the telematics system can alternate between a first mode and a second mode, in which power consumption is higher than in the first mode.

### BACKGROUND

The present invention relates to vehicle telematics systems and, more particularly, to determining the state of the ignition of an engine in a vehicle to control the vehicle telematics system.

Vehicle telematics systems provide vehicle information to people remote from the vehicle. One of the major applications of vehicle telematics systems includes GPS tracking of fleet or logistics vehicles. Information provided to a remote user enables fleet managers to make informed decisions about their fleet to increase efficiency and productivity. Other applications for vehicle telematics systems provide similar benefits.

### SUMMARY

In one embodiment, the invention provides a method of controlling a telematics system based on the ignition state of an engine in a vehicle. The term “ignition” has a historical connection to internal combustion engines signifying that the engine is on because ignition of fuel has been initiated. However, in a broader sense and with respect to embodiments of the present invention, ignition simply means that the source of motive power, for example, an electric motor, hybrid drive system, or engine, of a vehicle has been turned on or activated. The ignition state of the engine can alternate between an on state and an off state. The method includes monitoring, by a processor a voltage level on a diagnostics connector from the vehicle and monitoring, by the processor, an indicator of engine activity of the vehicle from the diagnostics connector of the vehicle. The method also includes determining, by the processor, the ignition state of the engine of the vehicle based on the voltage level and the indicator of engine activity and changing the operating mode of the telematics system based on the ignition state of the engine. The operating mode of the telematics system can alternate between a first mode and a second mode, in which power consumption is higher than in the first mode.

In another embodiment, the invention provides a method of determining an ignition state of an engine in a vehicle. The ignition state is alternatable between an on state and an off state. The method includes monitoring, by a processor, a voltage on a diagnostics connector in the vehicle, monitoring an indicator of engine activity from the diagnostics connector in the vehicle; and determining, by the processor, the ignition state of the engine based on the voltage and the indicator of engine activity.

In another embodiment, the invention provides a vehicle telematics device configured to connect to a diagnostics connector in a vehicle. The device includes a processor, a voltage change detector, a GPS receiver, and a radio transmitter. The voltage change detector, which is coupled to the diagnostics connector in the vehicle, is operable to monitor a voltage on the diagnostics connector. The processor is configured to alternate between a first operating mode and a second operating mode. The processor is also configured to receive information from the voltage change detector and monitor an indicator of engine activity of the vehicle through the diagnostics connector. The processor is also configured to determine the ignition state of the vehicle according to the information received from the voltage change detector and the indicator of engine activity and to operate in the first mode when the ignition is determined to be in the off state and operate in the second mode when the ignition is determined to be in the on state. The GPS receiver is coupled to the processor for performing telematics operations and the radio transmitter is coupled to the processor for performing telematics operations.

In another embodiment, the invention provides a vehicle telematics system including a remote processor, and a vehicle telematics device being operable to relay information to the remote processor. The vehicle telematics device includes a diagnostics connector configured to couple to a connector in a vehicle, a voltage change detector, and a processor. The voltage change detector is coupled to the diagnostics connector and is operable to monitor a voltage supplied to the vehicle telematics device via the diagnostics connector. The processor is configured to receive information from the voltage change detector, and to receive information from the diagnostics connector regarding general parameters of the vehicle, including revolutions per minute of an engine of the vehicle. The processor is also configured to compare the revolutions per minute to a first threshold. The processor is further configured to determine the ignition state of the vehicle based on the monitored voltage and revolutions per minute. The ignition state of the vehicle is alternatable between an on state and an off state.

In another embodiment, the invention provides a system configured to control a vehicle telematics processor based on the ignition state of an engine in a vehicle; the ignition state alternates between an on state and an off state. The system includes a diagnostics connector, coupled to a connector in the vehicle, and a voltage change detector coupled to the diagnostics connector. The voltage change detector is operable to monitor voltage changes in the diagnostics connector, compare the voltage on the diagnostics connector to a second threshold and to a third threshold, calculate a voltage difference between two voltage measurements, and compare the voltage difference to a first delta threshold. The system also includes a processor configured to receive information from the voltage change detector, receive information about the vehicle through the diagnostics connector, including the revolutions per minute of an engine of the vehicle, and compare the revolutions per minute to a first threshold. The processor is further configured to determine that the ignition state is on if the voltage difference is greater than the first delta threshold and the revolutions per minute exceed the first threshold, or if the voltage difference exceeds the first delta threshold and the voltage exceeds the second threshold; and determine that the ignition state is in the off state if the revolutions per minute do not exceed the first threshold and the voltage the voltage does not exceed the second threshold, or if the processor does not receive information regarding the revolutions per minute of the vehicle. The system is further configured to alternate between a first operating mode and a second mode, in which power consumption is higher than in the first operating mode; the processor operates in the first mode when the ignition state is off and the processor operates in the second mode when the ignition state is on.

Other aspects of the invention will become apparent by consideration of the detailed description and accompanying drawings.

### BRIEF DESCRIPTION OF THE DRAWINGS

FIG. 1 illustrates an example of a prior art device.

FIG. 2 illustrates a vehicle telematics device according to one embodiment of the present invention.

FIG. 3 is a graph of voltage changes when the ignition changes from an off state to an on state.

FIG. 4 is a flowchart showing the process to determine that the ignition of an engine is in the on state.

FIG. 5 is a flowchart showing the process to calibrate a second threshold.

FIG. 6 is a flowchart showing the process to determine that the ignition of the engine is in the off state.

FIG. 7 is a flowchart showing the process to calibrate a third threshold.

FIG. 8 is a graph of voltage changes when the ignition changes from the on state to the off state.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

A vehicle telematics device monitors general operations of a vehicle. Normally, the illustrated vehicle telematics device operates in a fully operational mode (or, more simply, “operational mode”) in which the vehicle telematics device monitors, for example, motion and speed of the vehicle, location, and fuel consumption. One way to reduce power consumption of the vehicle telematics device is to lower power consumption of the vehicle telematics device by operating in a “sleep mode” while a vehicle is not running. During the sleep mode, the vehicle telematics device usually does not perform monitoring functions, although in some cases the telematics device may still perform monitoring functions, but without providing power to all of its subassemblies or submodules.

The vehicle telematics device can alternate between operating in the fully operational mode and the sleep mode depending on the state of an ignition of an engine in the vehicle. The ignition of the engine alternates between an on state, in which the vehicle engine is running, and an off state, in which the vehicle engine is not operating. The vehicle telematics device can then respond to the change in ignition state by alternating between sleep mode and fully operational mode. For example, when the ignition state is on, the vehicle telematics device operates in the fully operational mode. When the ignition state is off, the vehicle telematics system operates in sleep mode since it does not need to provide power to all of its subassemblies during this time.

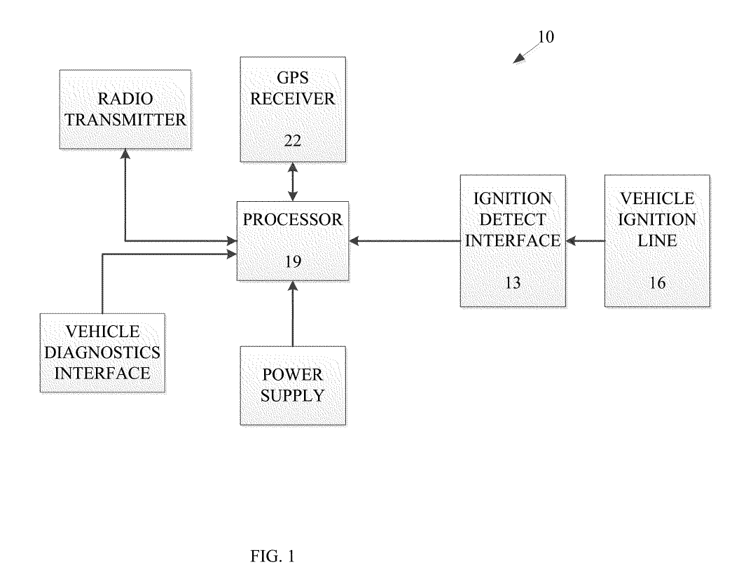

As shown in FIG. 1, a vehicle telematics device 10 of the prior art determines the ignition state of the engine of a vehicle by introducing an ignition detect interface 13 connected to a vehicle ignition line 16. In the illustrated prior art device 10, the ignition detect interface 13 is also connected to a processor 19 in the vehicle telematics device 10. Several problems with the prior art have been recognized, including that the ignition detect interface 13 is often connected to the wrong line and provides erroneous information to the processor 19. Prior techniques and technologies have also used motion detectors and GPS information from a GPS receiver 22 to determine the ignition state of the engine in the vehicle.

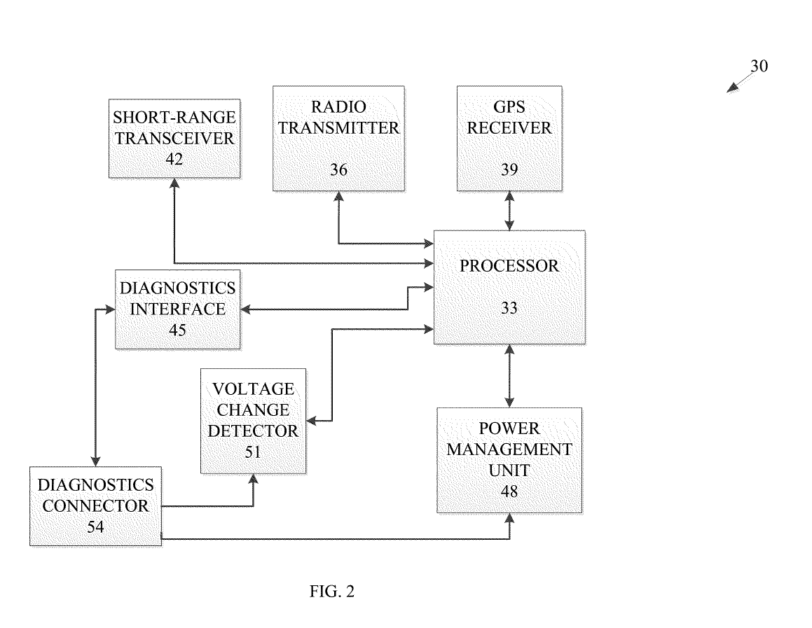

As shown in FIG. 2, the illustrated embodiment includes a vehicle telematics device 30 including a processor 33, a radio transmitter 36, a GPS receiver 39, a short-range frequency receiver 42, a diagnostics interface 45, a power management unit 48, a voltage change detector 51, and a diagnostics connection 54. The processor 33 receives and sends information from and to the radio transmitter 36, the GPS receiver 39, and the short-range frequency receiver 42. The short-range frequency receiver 42 can be, for example, a WLAN/Bluetooth receiver. In some embodiments, the vehicle telematics device 30 may also include a long-range receiver that can receive, for example, a wireless internet signal. In the illustrated embodiment, the diagnostics interface 45 and the diagnostics connection 54 are On-Board Diagnostics II (OBDII) compatible. In other embodiments, other diagnostic interfaces and connections can also be used. As a shortcut to describing the messages and signals communicated to the processor 33 by the diagnostics connector 54, Applicant will refer to the quantity (e.g., revolutions per minute, voltage, etc.) rather the actual signal transmitted.

The processor 33 also communicates with the power management unit 48 regarding voltage and current required to run the processor 33. The power management unit 48 receives power through the diagnostics connector 54 from a battery in the vehicle. The power management unit 48 converts the voltage from the battery into a lower voltage suitable for the processor 33. To accomplish this conversion, the power management unit 48 can include a DC-to-DC converter. For example, the power management unit 48 may receive 12V through the diagnostics connector 54 and convert it to 3V to power the processor 33. The power management unit 48 also receives information from the processor 33 regarding current limits. The power management unit 48 ensures that the appropriate voltage and current enters the processor 33 to prevent any damage to the processor 33.

The processor 33 receives information from the voltage change detector 51 regarding the voltage changes on the power line of the diagnostics connector 54. The voltage change detector 51 receives a voltage from the power line of the diagnostics connector 54. The voltage change detector 51 then calculates a voltage difference between two consecutive voltage samples and compares both the measured voltage and the voltage difference to predetermined thresholds to determine the ignition state of the engine. The voltage change detector 51 communicates with the processor 33 regarding the ignition state of the engine. If processor 33 determines that the ignition is in the off state, the processor 33 decreases its power consumption by operating in the sleep mode.

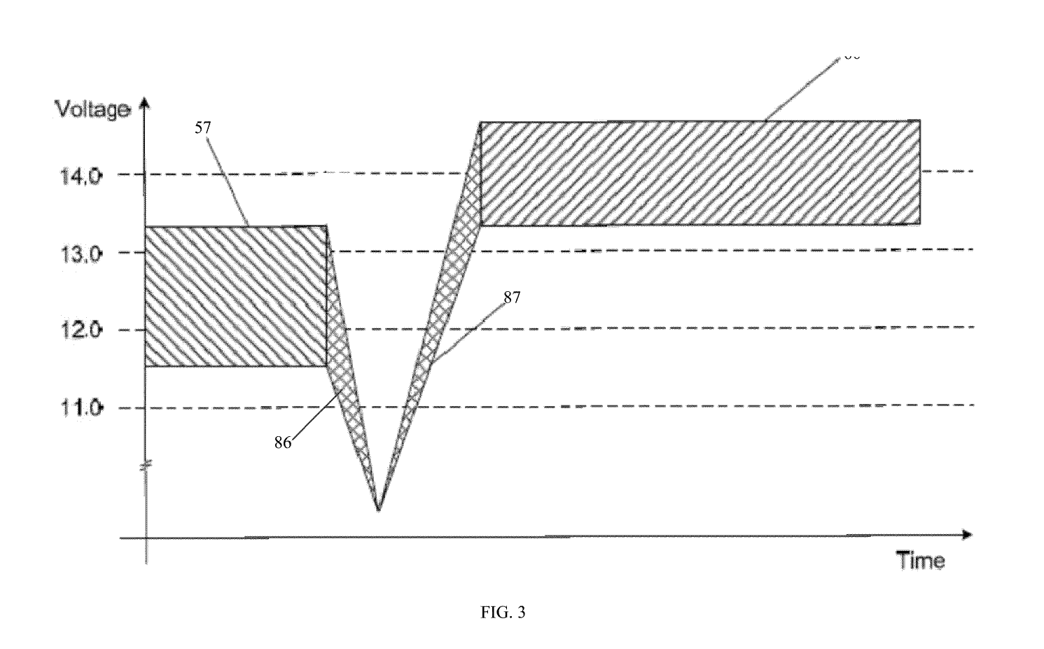

If the processor 33 determines that the ignition is in the on state, the processor 33 operates in the fully operational mode. The voltage change detector 51 detects the ignition of the engine is in the on state by monitoring the voltage on the power line of diagnostics connector 54. While the ignition of the engine is in the off state, the voltage on the power line of the diagnostics connector 54 comes from a battery in the vehicle, as shown in section 57 of FIG. 3. However, section 60 of FIG. 3 shows that when the ignition of the engine is in the on state, the voltage on the power line of the diagnostics connector 54 comes from a regulated output from an alternator in the vehicle. The voltage output from the alternator is higher than the voltage from the battery. The voltage output from the battery, section 57, is between about 11.5-13.3V. The voltage output from the alternator, section 60, is between about 13.3-14.9V.

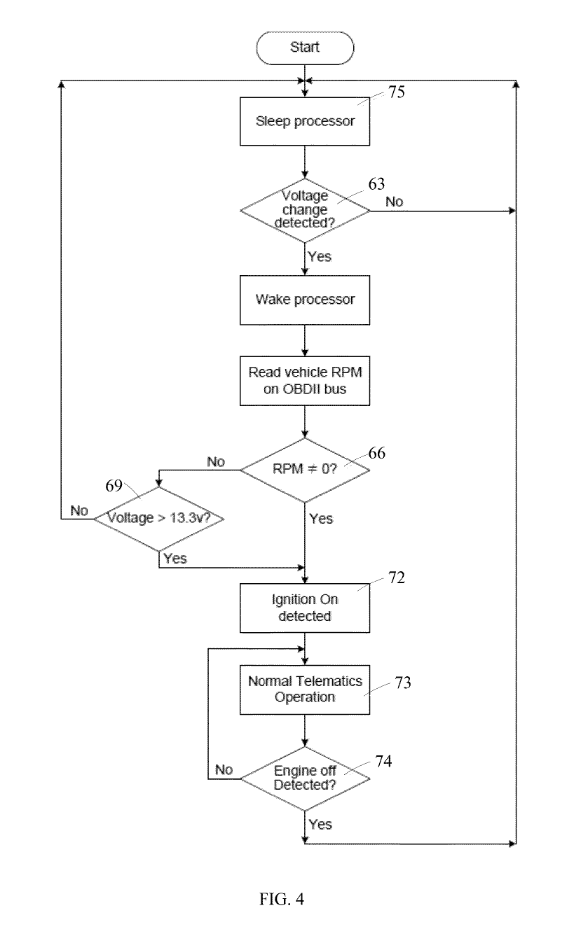

As shown in FIG. 4, the voltage change detector 51 detects the change in measured voltage on the power line of the diagnostics connector 54 by calculating a voltage difference between consecutive voltage measurements. When the ignition of the engine switches between the off state and the on state (block 63), the voltage difference calculated by the voltage change detector 51 is greater than a first delta threshold. The first delta threshold may be, for example, 0.75V/250 milliseconds. If the voltage difference does not exceed the first delta threshold, the voltage difference does not necessarily correspond to a change in state of the ignition of an engine and may be caused by other factors. If the voltage difference exceeds the first delta threshold, a secondary condition is used to verify that the ignition is in the on state.

A secondary condition includes having the processor 33 determine if revolutions per minute (“RPM”) of an engine of the vehicle exceed a first threshold (block 66). In a four-stroke internal combustion engine, RPM is generally a measure of rotations of a crankshaft. Electric motors and other engines typically have an output shaft from which RPM can be measured. More broadly speaking, RPM is a measure or indicator of engine activity. The first threshold can be, for example, zero revolutions per minute. If the revolutions per minute from the diagnostics connector 54 are greater than zero, the processor 33 confirms that the ignition is in the on state.

Another secondary condition includes determining if the voltage level from the power line of the diagnostics connector 54 is higher than a second threshold (block 69). The second threshold can be, for example, 13.3V. In some embodiments, a time component is incorporated into the second threshold. For example, the voltage change detector 51 determines if the voltage level on the power line of the diagnostics connector 54 is 13.3V or higher for a predetermined amount of time, for example 60 seconds.

The processor 33 determines that the ignition is in the on state when the voltage difference calculated by the voltage change detector 51 is greater than a first delta threshold and at least one of the secondary conditions is met (block 72). If the ignition of the engine is in the on state, the processor 33 operates in the fully operational mode and conducts normal telematics operations (block 73). If the ignition of the engine is in the off state (block 74), the processor 33 begins to or continues to operate in the sleep mode (block 75). Thus, the processor 33 determines that the ignition of the engine is in the on state if the voltage difference exceeds the first delta threshold (block 63) and the revolutions per minute exceed the first threshold, e.g., are non-zero (block 66), or if the voltage difference exceeds the first delta threshold (block 63) and the voltage exceeds the second threshold (block 69).

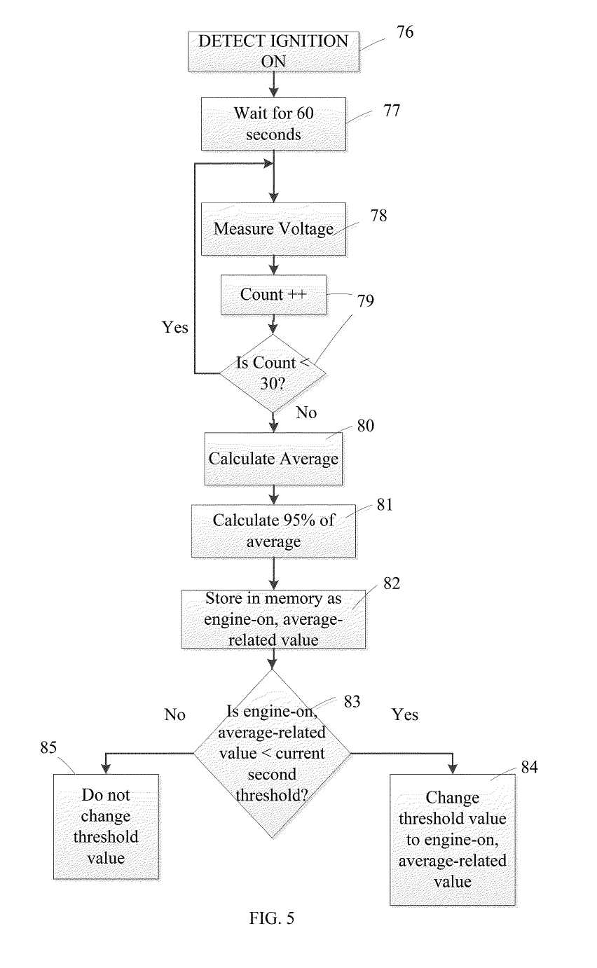

In the illustrated embodiment, the second threshold can be altered according to a calibration procedure, as shown in FIG. 5, performed by the processor 33. In certain embodiments, the calibration procedure occurs a predetermined time period (block 76) after the ignition is detected to be in the on state (block 77). The calibration procedure includes measuring the vehicle battery voltage level (block 78) for a predetermined number of times, for example, 30 times with 10 second intervals (block 79). The processor 33 then calculates an average of the measured vehicle battery voltage levels (block 80). The processor 33 then calculates a value lower than the average from the measured values (block 81), for example, the processor 33 calculates about 95% of the average value and stores the value in memory as an ignition-on, average-related value (block 82). Then, the processor compares the ignition-on, average-related value to the currently used value for the second threshold (block 83). If the ignition-on, average-related value is lower than the currently used value for the second threshold, the processor 33 begins using the saved ignition-on, average-related value as the second threshold (block 84). If the ignition-on, average-related value is higher than the currently used value for the second threshold, the processor 33 discards the ignition-on, average-related value and continues to use the currently used value for the second threshold (block 85). When the vehicle telematics device 30 is used in a new vehicle, the processor 33 uses a default value for the second threshold, for example 13.3V. The calibration procedure for the second threshold is performed every time the engine on is detected in the same vehicle. If the engine is detected to be on for a period of time shorter than the predetermined hold period, 60 seconds in the illustrated embodiment, an engine-on, average-related value is not calculated and the current value for the second threshold is maintained. If a user removes the vehicle telematics device 30 from the vehicle and later reconnects the vehicle telematics device 30, the second threshold sets to the default value, 13.3V in the illustrated embodiment.

Referring back to FIG. 3, during the transition of the ignition of the engine from the off state to the on state, other changes in the voltage on the power line of the diagnostics connector 54 also occur. For example, immediately after the ignition of the engine alternates from the off state to the on state, the voltage on the power line of the diagnostics connector 54 decreases significantly due to the added load of a starter motor to the battery voltage, as shown by section 86. After a large decrease in voltage, the voltage on the power line of the diagnostics connector 54 slowly increases, section 87, to reach the voltage output from the alternator in section 60. The drop in voltage, section 86, on the power line of the diagnostics connector 54 does not usually occur in electric or hybrid vehicles since electric or hybrid vehicles usually do not have a starter motor. Similarly, if the vehicle telematics device 30 is connected to a gasoline driven vehicle after the ignition has changed from the off state to the on state (after the vehicle has been turned on) the large decrease in voltage, section 86, would not be observed in the voltage of the power line of the diagnostics connector 54. However, the voltage increase, section 87, from about 11.5-13.3V to 13.3-14.9V still occurs in all vehicles.

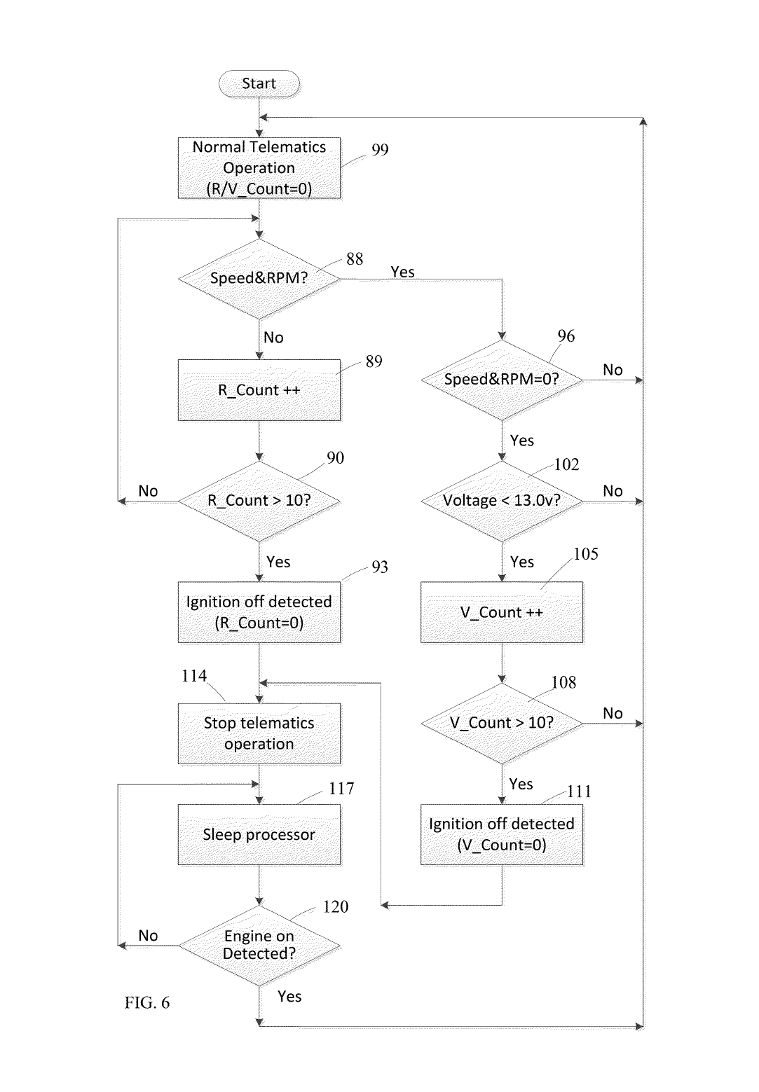

As shown in FIG. 6, to operate in the sleep mode, the processor 33 determines that the ignition of the engine is in the off state and operates in the sleep mode. The processor 33 determines that the ignition of the engine is in the off state by receiving information from the voltage change detector 51 regarding the voltage on the power line of the diagnostics connector 54 and by receiving information from the diagnostics connector 54 through the diagnostics interface 45 regarding the revolutions per minute of the engine of the vehicle (block 88). If the processor 33 does not receive information regarding the revolutions per minute of the engine, the processor 33 attempts to read the revolutions per minute of the engine through the diagnostic interface 45 again. The processor 33 continues to attempt to read the revolutions per minute of the engine through the diagnostics interface 33 for a predetermined number of times, for example, ten (blocks 89, 90). If the processor 33 still does not obtain any information regarding the revolutions per minute of the engine through the diagnostic interface 45 after the processor 33 has attempted to read the revolutions per minute of the engine the predetermined number of times, the ignition of the engine is determined to be in the off state (block 93).

If the processor 33 receives information regarding the revolutions per minute of the engine (block 88), the processor 33 compares the revolutions per minute of the engine to the first threshold (block 96). If the revolutions per minute of the engine are greater than the first threshold, the processor 33 determines that the ignition is in the on state and the vehicle telematics device 30 performs normal telematics operations (block 99). If the revolutions per minute of the engine do not exceed the first threshold, the processor uses the information from the voltage change detector 51 to verify the state of the ignition of the engine.

The voltage change detector 51 compares the voltage on the power line of the diagnostics connector 54 to a third threshold (block 102) and communicates the result of the comparison to the processor 33. In the illustrated embodiment, the third threshold is 13.0V. If the voltage on the power line of the diagnostics connector 54 is detected to be greater than the third threshold, the processor 33 determines that the ignition of the engine is in the on state and general telematics are performed (block 99). However, if the voltage on the power line of the diagnostics connector 54 does not exceed the third threshold for a predetermined period of time (blocks 105, 108), the processor 33 determines that the ignition of the engine is in the off state (block 111).

Thus, the processor determines that the ignition of the engine is in the off state if the processor 33 does not receive information regarding the revolutions per minute of the engine after a predetermined number of attempts are made to read the revolutions per minute through the diagnostic interface 45 (blocks 89, 90), or if the revolutions per minute of the engine do not exceed the first threshold (block 96) and the voltage on the power line of the diagnostics connector 54 does not exceed the third threshold for a predetermined period of time (block 102, 105, 108).

As soon as the ignition of the engine is detected to be in the off state, the processor 33 stops telematics operations (block 114) and begins to operate in the sleep mode (117). During the sleep mode, power consumption from the vehicle telematics device 30 significantly decreases and the voltage change detector 51 monitors the voltage on the power line of the diagnostics connector 54 to detect if the ignition alternates to the on state (block 120).

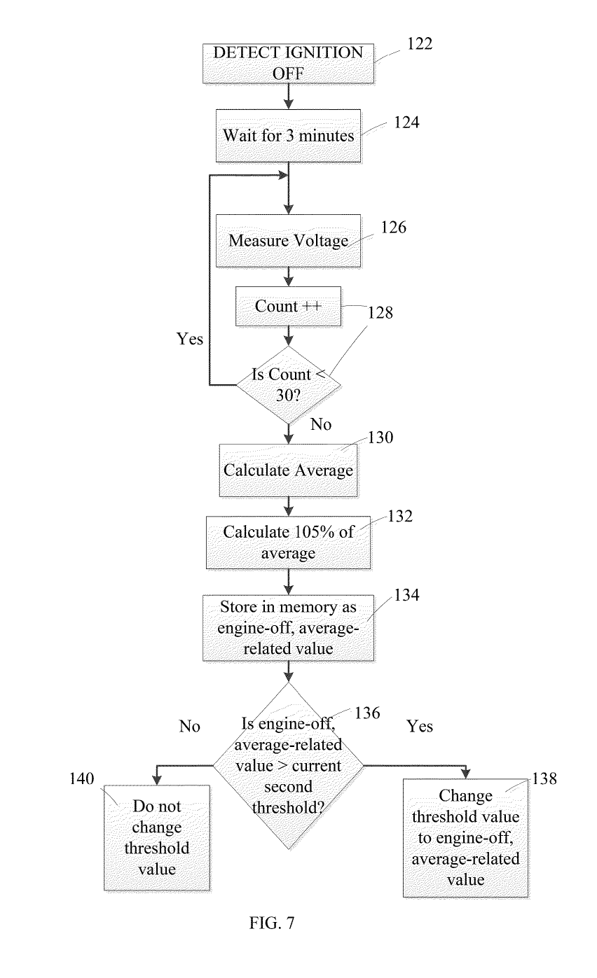

As shown in FIG. 7, the third threshold is adjustable according to an average value. In the illustrated embodiment, the processor 33 detects that the engine is in the off state (block 122) and waits for a predetermined hold period, for example three minutes (block 124). After the predetermined hold period has elapsed, the processor 33 measures the vehicle battery voltage (block 126) a predetermined number of times, for example 30 times (block 128). The processor 33 then calculates an average value from the number of samples measured (block 130). The processor calculates and stores in memory a value higher than the average value from the vehicle battery voltage samples as an ignition-off, average-related value (blocks 132, 134). In the illustrated embodiment, the stored value is 105% of the average value. The processor 33 then compares the engine-off, average-related value to the value currently used as the third threshold (block 136). If the engine-off, average-related value is greater than the value currently used as the third threshold, the processor 33 modifies the third threshold to use the engine-off, average-related value (block 138). If the engine-off, average-related value is less than the value currently used as the third threshold, the processor 33 does not modify the third threshold (block 140). The calibration procedure for the third threshold is performed each time the engine is detected to be in the off state. If the engine is detected to be in the off state for a period shorter than the hold period, no average is calculated and the current value for the third threshold is maintained. If a user removes the vehicle telematics device 30 from the diagnostics connector in the vehicle and later reconnects the vehicle telematics device 30 to the vehicle, the third threshold is set to a default value. In the illustrated embodiment the default value is about 13.0V.

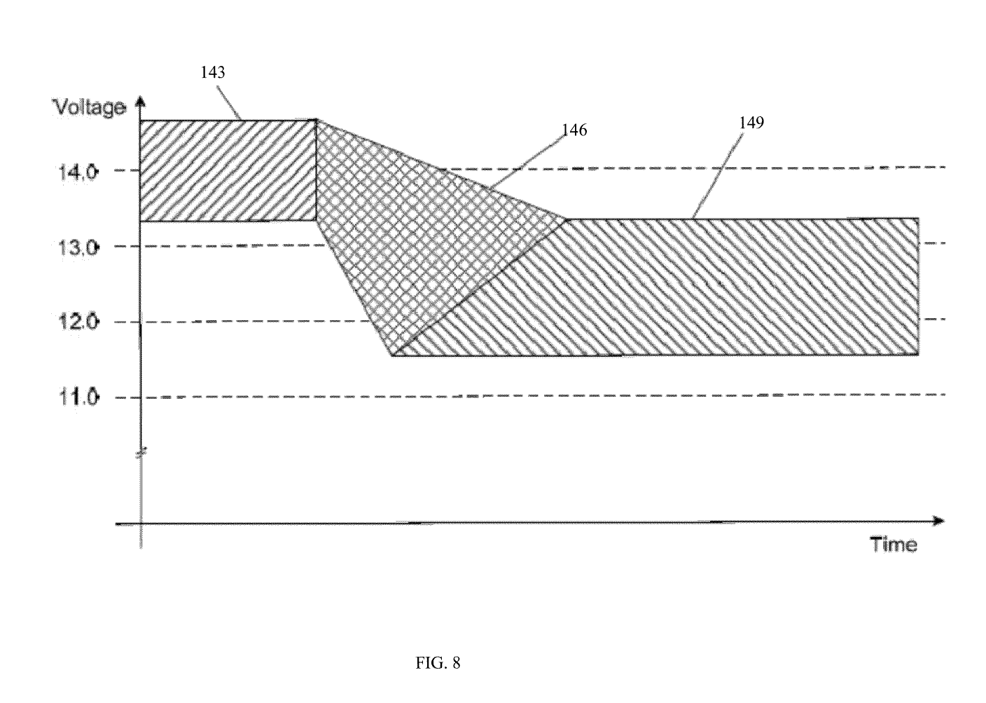

As illustrated in FIG. 8, in other embodiments, the ignition of the engine can be determined to be in the off state by measuring only changes in the voltage on the power line of the diagnostics connector 54. When the car is running and the ignition of the engine is in the on state, the voltage on the power line of diagnostics connector 54 is measured to be about between 13.3-14.9V from the alternator output, section 143. When the ignition state of the engine changes from the on state to the off state, the voltage on the power line of the diagnostics connector 54 changes, section 146, from about 13.3-14.9V to between 11.5-13.3V, section 149. The voltage change detector 51 monitors the changes in voltage on the power line of the diagnostics connector 54 to detect a decrease in voltage to below about 13.3V. The change in voltage when the ignition of the engine changes from the on state to the off state varies in time duration. The time of transition from higher voltage to lower voltage varies from a few seconds up to several minutes depending on many factors, including, for example, battery life and remaining load on the battery.

Thus, the illustrated vehicle telematics device 30 can lower its power consumption by alternating between the fully operational mode while the ignition of the engine is in the on state, and the sleep mode while the ignition of the engine is in the off state. The “engine” is a source of motive power of a vehicle and may include an internal combustion engine, an electric motor, a hybrid power train, or other device designed for similar purposes. The processor 33 determines the state of the ignition of the engine and alternates operation between the sleep mode and the fully operational mode depending on the state of the ignition of the engine.

The illustrated vehicle telematics device 30 connects directly to a diagnostics connector in a vehicle. The diagnostics connector in a vehicle is easily accessible to the user and does not require much installation effort. Thus, the illustrated vehicle telematics device offers the user a convenient and easy-to-connect vehicle telematics device requiring lower power consumption.

Various features and advantages of the invention are set forth in the following claims.

What is claimed is:

1. A method of controlling a telematics system based on the ignition state of an engine in a vehicle, the ignition state of the engine alternating between an on state and an off state, the method comprising:
monitoring, by a processor, a voltage on a diagnostics connector from the vehicle;
monitoring, by the processor, an indicator of engine activity from a diagnostics connector of the vehicle;
determining, by the processor, the ignition state of the engine of the vehicle based on the detected voltage and the indicator of engine activity; and
changing the operating mode of the telematics system based on the determined ignition state of the engine between a first mode and a second mode, the second mode having a power consumption that is higher than the power consumption in the first mode.

2. The method of claim 1, wherein monitoring, by the processor, an indicator of engine activity from the diagnostics connector includes monitoring revolutions per minute of an engine of the vehicle.

3. The method of claim 2, wherein monitoring, by the processor, revolutions per minute of an engine of the vehicle from the diagnostics connector includes:
determining if the revolutions per minute are greater than a first threshold.

4. The method of claim 1, wherein monitoring, by a processor, a voltage level on a diagnostics connector from the vehicle includes:
comparing the voltage level to a second threshold and to a third threshold;
calculate a voltage difference between two consecutive voltage samples; and
determining if the voltage difference is greater than a first delta voltage threshold.

5. The method of claim 4, wherein determining, by the processor, the ignition state of the engine of the vehicle based on the detected voltage and revolutions per minute includes:
determining that the ignition is on if the voltage difference exceeds the first delta threshold, and the revolutions per minute are greater than the first threshold;
determining that the ignition is on if the voltage difference exceeds the first delta threshold, and the voltage exceeds the second threshold;
determining that the ignition is off if the revolutions per minute do not exceed the first threshold and the voltage does not exceed the third threshold;
determining that the ignition is off if the processor does not receive information regarding the revolutions per minute.

6. The method of claim 5, wherein the processor operates in the first operating mode when the ignition state of the vehicle is off, and operates in the second operating mode when the ignition state of the vehicle is on.

7. A method of determining an ignition state of an engine in a vehicle, the ignition state alternating between an on state and an off state, the method comprising:
monitoring, by a processor, a voltage on a diagnostics connector in the vehicle;
monitoring, by the processor, an indicator of engine activity of the vehicle from the diagnostics connector in the vehicle; and
determining, by the processor, the ignition state of the engine based on the voltage and the indicator of engine activity of the vehicle.

8. The method of claim 7, wherein monitoring, by the processor, an indicator of engine activity from the diagnostics connector in the vehicle includes:
detecting the revolutions per minute of the engine of the vehicle; and
comparing the revolutions per minute to a first threshold.

9. The method of claim 7, wherein monitoring, by a processor, a voltage on a diagnostics connector in the vehicle includes:
comparing the voltage to a second threshold and a third threshold;
calculating a voltage difference between two consecutive voltages; and
comparing the voltage difference to a first delta threshold.

10. The method of claim 9, wherein determining, by the processor, the ignition state of the engine based on the voltage and revolutions per minute includes:
determining that the ignition is on if the voltage difference exceeds the first delta threshold, and the revolutions per minute are greater than the first threshold;
determining that the ignition is on if the voltage difference exceeds the first delta threshold, and the voltage exceeds the second threshold;
determining that the ignition is off if the voltage difference does not exceed the first delta threshold;
determining that the ignition is off if the voltage difference exceeds the first delta threshold, the revolutions per minute do not exceed the first threshold, and the voltage does not exceed the second threshold;
determining that the ignition is off if the revolutions per minute do not exceed the first threshold and the voltage does not exceed the third threshold;
determining that the ignition is off if the processor does not receive information regarding the revolutions per minute.

11. A vehicle telematics device configured to connect to a diagnostics connector in a vehicle, the device comprising:
a voltage change detector coupled to the diagnostics connector in the vehicle, the voltage change detector operable to monitor a voltage on the diagnostics connector;
a processor configured to:
alternate between a first operating mode and a second operating mode;
receive information from the voltage change detector regarding the voltage on the diagnostics connector;
monitor an indicator of engine activity;
determine the ignition state of an engine according to the information received from the voltage change connector and the revolutions per minute; and
operate in the first mode when the ignition is determined to be in the off state and operate in the second mode when the ignition is determined to be in the on state;
a GPS receiver coupled to the processor for performing telematics operations; and
a radio transmitter coupled to the processor for performing telematics operations.

12. The vehicle telematics device of claim 11, wherein the second operating mode has a power consumption from the vehicle telematics device higher than the power consumption of the first operating mode.

13. The vehicle telematics device of claim 12, wherein the indicator of engine activity is revolutions per minute of the engine, and wherein the processor is further configured to compare the revolutions per minute of the engine the vehicle to a first threshold.

14. The vehicle telematics device of claim 13, wherein the voltage change detector is further configured to:
compare the voltage provided to the vehicle telematics device from the vehicle to a second threshold and to a third threshold;
calculate a voltage difference between two voltage measurements; and
compare the voltage difference to a first delta voltage threshold.

15. The vehicle telematics device of claim 14, wherein the processor determines that the ignition state is on if the voltage difference exceeds the first delta voltage threshold and the revolutions per minute exceed the first threshold, if the voltage difference exceeds the first delta threshold and the voltage exceeds the second threshold; and the processor determines that the ignition state is off if the revolutions per minute do not exceed the first threshold and the voltage does not exceed the third threshold, or if the processor does not receive information regarding the revolutions per minute.

16. The vehicle telematics device of claim 15, further including communication means to relay information regarding the vehicle to a remote processing unit.

17. A vehicle telematics system comprising:
a remote processor;
a vehicle telematics device, operable to relay information to the remote processor, including:
a diagnostics connector configured to couple to a connector in a vehicle;
a voltage change detector coupled to the connector, the voltage change detector operable to monitor a voltage supplied to the vehicle telematics device via the diagnostics connector;
a processor configured to:
receive information from the voltage change detector regarding the voltage;
receive information from the diagnostics connector regarding general parameters of the vehicle, including revolutions per minute of an engine;
compare revolutions per minute of the engine to a first threshold; and
determine the ignition state of the vehicle based on the monitored voltage and revolutions per minute, the ignition state of the vehicle alternatable between an on state and an off state.

18. The vehicle telematics system of claim 17, wherein the voltage change detector is further configured to compare the voltage provided to the vehicle telematics device from the vehicle to a second threshold and to a third threshold; detect a voltage difference between two voltage measurements; and compare the voltage difference to a first delta voltage threshold.

19. The vehicle telematics system of claim 18, wherein the processor determines that the ignition state is on if the voltage difference exceeds the first delta voltage threshold and the revolutions per minute exceed the first threshold, or if the voltage difference exceeds the first delta threshold and the voltage exceeds the second threshold; and the processor determines that the ignition state is off if the revolutions per minute do not exceed the first threshold and the voltage does not exceed the third threshold.

20. The vehicle telematics system of claim 19, wherein the processor is further configured to alternate between a first operating mode and a second operating mode, in which power consumption for the vehicle telematics device is higher than in the first mode.

21. The vehicle telematics system of claim 20, wherein the processor operates in the first operating mode when the ignition state is off and in the second operating mode when the ignition state is on.

22. A system configured to determine the ignition state of an engine in a vehicle, the ignition state alternatable between an on state and an off state, the system comprising:
a diagnostics connector, coupled to a connector in the vehicle;
a voltage change detector coupled to the diagnostics connector operable to monitor voltage changes in the diagnostics connector, compare the voltage on the diagnostics connector to a second threshold and to a third threshold, calculate a voltage difference between two voltage measurements, and compare the voltage difference to a first delta voltage threshold; and
a processor coupled to the diagnostics connector and to the voltage change detector, the processor configured to:
receive information from the voltage change detector;
receive information about the vehicle through the diagnostics connector, including revolutions per minute of an engine of the vehicle;
compare the revolutions per minute to a first threshold;
determine that the ignition state is on if the voltage difference is greater than the first delta threshold and the revolutions per minute are greater than the first threshold, or if the voltage difference exceeds the first delta threshold and the voltage exceeds the second threshold;
determine that the ignition state is off if the revolutions per minute do not exceed the first threshold and the voltage does not exceed the third threshold, or if the processor does not receive information regarding the revolutions per minute of the vehicle; and
alternate between a first operating mode, in which power consumption of the processor is low, and a second operating mode, in which power consumption of the processor is higher than in the first operating mode;
wherein the processor operates in the first mode when the ignition state is off and the processor operates in the second mode when the ignition state is on.
